(19) United States
(12) Patent Application Publication
(10) Pub. No.: US 2018/0158573 A1
(43) Pub. Date: Jun. 7, 2018

(54) POWER TRANSMISSION CABLE

(71) Applicant: ABB HV CABLES (SWITZERLAND) GMBH, Baden, Aargau (CH)

(72) Inventors: Chau-Hon HO, Lörrach (DE); Cherif GHOUL, Raleigh, NC (US)

(73) Assignee: ABB SCHWEIZ AG, Baden (CH)

(21) Appl. No.: 15/306,736

(22) PCT Filed: Jun. 30, 2014
(86) PCT No.: PCT/EP2014/063819

§ 371 Date: Oct. 25, 2016

(51) Int. Cl. H01B 9/02; H01B 3/44; H01B 13/14; C08K 9/02; C08K 3/34; C08K 3/22; C08K 7/00

(52) U.S. Cl. CPC H01B 9/027; H01B 3/441; H01B 13/141; C08K 9/02; C08K 3/34; C08K 2201/019; C08K 7/00; C08K 3/22; C08K 2003/2282; C08K 2201/001; C08K 2003/2227; C08K 3/2279

(57) ABSTRACT

A high voltage or medium voltage transmission power cable includes a metallic conductor and an insulation system including an electrical insulation layer including a first composite material, and a semiconducting layer including a second composite material. The insulation layer and the semiconducting layer are arranged to surround the conductor. The first composite material in the insulation layer includes a polymer matrix and first inorganic conductive filler particles, wherein the amount of the first inorganic conductive filler particles is from 0.1 to 10 wt-%, based on the total weight of the first composite material, and wherein the first inorganic conductive filler particles are other than carbon black. A method of manufacturing the cable is also disclosed.

### TECHNICAL FIELD

The present invention relates to the field of high voltage or medium voltage transmission power cables comprising a conductor and an insulation system comprising an electrical insulation layer and a semiconducting layer. The invention also relates to a process for the production of such cable.

### BACKGROUND

High voltage or medium transmission power cables are used to transfer electrical power from one location to another, and are often buried underground or placed at the bottom of the sea. The cables may be high- or medium voltage direct current (HVDC, MVDC) cables or high- or medium voltage alternating current (HVAC, MVAC) cables. Such cables comprise a metallic conductor surrounded by an insulation layer. Unless the cables are appropriately insulated, significant leakage currents will flow in the radial direction of the cables, from the conductor to the surrounding ground or water. Such leakage currents give rise to significant power losses, as well as to heating of the electrical insulation. The heating of the insulation can further increase the leakage current due to the reduction of the resistance with increasing temperature. To avoid power loss and possible thermal runaway, the leakage current should therefore be kept as small as possible.

In order to reduce the leakage current, electrical insulation systems where an insulating material of low DC-conductivity is arranged to surround the conductor of a transmission power cable are widely used. Various polymeric materials are used as an insulation layer in the insulation systems in transmission cables, such as polyethylene, polypropylene or thermoplastic elastomers, polyurethane and cross-linked polyethylene (XLPE) or ethylene-propylene-diene M-class rubber (EPDM). Especially in medium and high voltage transmission cables XLPE is widely used and LDPE is used as a base resin.

However, each polymer matrix has its inherent limits in electrical and thermo-mechanical properties restricting the performance of the overall product. There is always the need for improvement of the polymeric insulation. For example it is desirable to increase voltage or current rating and improve reliability. It is also desirable to improve space charge behavior to improve the electrical properties of transmission cables.

There have been many attempts in the prior art to improve insulation systems. For example, inorganic fillers with insulating property have been introduced to insulation systems to improve insulating properties. WO2012/150285 is a prior art document showing the use of hydrotalcite as an insulating filler material. Each of JP4368718A, JP7021850A, JP 10269852A, JP11086634A, JP 11232942A, JP2006291022A, JP2010280838A, WO2011/122742, WO2011/092533, US 2012000694, respectively, shows the use of magnesium oxide as an insulating filler material. Further, EP1033724, KR20100096392 show the use of clay as an insulating filler material.

Some work and patents have been published where carbon black as conductive filler is used in a polymeric composite for insulation application. JP2013026048 discloses the use of carbon black as filler. A published article, from an inventor in that application (JP2013026048) defining the use of carbon black, named: “Effect of conductive inorganic filler on space charge characteristics in XLPE as a HVDC insulating material; 8^{th} International Conference on Insulated Power Cables, Jicable*11-19-23 Jun. 2011” discusses effects on charge behavior, however without specifying the type of the filler. US20100122833 and WO2011093211 disclose the use of carbon black as a filler material. Further, the article “D. van der Born, I. A. Tsekmes, T. J. Person, S. J. Sutton, P. H. F. Morshuis, J. J. Smit, Evaluation of space charge accumulation processes in small size polymeric cable models, Annual Report Conference on Electrical Insulation and Dielectric Phenomena (CEIDP), 2012, pp. 669-672.” also shows the use of carbon black. However, carbon black suffers from many disadvantages, such as relatively low thermal resistance, relatively low mechanical abrasion and chemical resistance (e.g. oxidation).

Despite several attempts to improve insulation materials, there is still a need to improve electrical properties of transmission power cables and improve reliability of the transmission cables.

### SUMMARY OF THE INVENTION

Thus, it is an object of the present invention to provide a transmission power cable with an electrical insulation layer having improved insulation properties and which is suitable for high voltage or medium voltage power cable applications.

It is a further object of the invention to provide an insulation layer that does not require modification of the polymer matrix.

It is a still further object of the invention to provide an improved and modified insulation material which is simple and cost-efficient.

A still further object of the present invention is to provide reliable transfer of electrical power.

It is also an object of the present invention to provide a power transmission cable, and especially an HVDC or MVDC cable having improved space charge behavior, i.e. low accumulation of charge and/or presence of homocharge in case of accumulation and fast charge decay if accumulation occurs.

The above-mentioned objects are achieved by a high voltage or medium voltage transmission power cable comprising a metallic conductor and an insulation system comprising an electrical insulation layer comprising a first composite material and a semiconducting layer comprising a second composite material. The electrical insulation layer preferably consists of the first composite material and the semiconducting layer preferably consists of the second composite material. The insulation layer and the semiconducting layer are arranged to surround the conductor. The insulation layer and the semiconducting layer are preferably arranged radially and concentrically to surround the conductor. Preferably, the cable comprises at least two semiconducting layers. The first composite material in the insulation layer comprises a polymer matrix and first inorganic conductive filler particles, wherein the amount of the first inorganic conductive filler particles is from 0.1 to 10 weight (wt)-%, and wherein the first inorganic conductive filler particles are other than carbon black.

The first inorganic conductive filler particles may comprise particles of at least one of metal oxide mineral, alumina, silica, silicates or aluminosilicates. The particles are coated with a conductive layer. By coating the particles with a conductive layer, desired conductive and other properties may be provided to the particles. The conductive layer may comprise at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SiC, B₄C, WC, W₂C, TiC, ZrC, HfC, NbC, TaC, Cr₃C₂, Mo₂C, SnₓSb_{y}O_{z}, or a metal layer of aluminium or a noble metal. Suitably, the conductive layer is based on SnₓSb_{y}O_{z}, such as SnSbO₂.

According to one variant of the present invention, the first inorganic conductive filler particles are carbon-free or essentially carbon-free. Such particles have been found to be particularly suitable to be coated with a conductive layer, which may comprise at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SnₓSb_{y}O_{z}, such as SnSbO₂ or a metal layer of aluminum or a noble metal.

The particles may be also of pure metal, such as of aluminum, e. g. in powder form. Such particles or powders are relatively easy to manufacture and may render the desired electrical properties to the insulation layer.

The first inorganic conductive filler particles may have a platelet-like shape. Such filler particles further improve the dielectric strength of insulation materials.

The largest dimension of the first conductive filler particle, herein referred to as size of the particle, may be from 0.1 to 100 μm, measured as the largest dimension of the particle visible in a SEM (Scanning electron microscope)-image. The specific size contributes to preventing a conductive path in the insulation material. The specific size especially together with the specific platelet-like shape of the particles contributes further among other things to preventing that a conductive path in the insulation material is formed.

The amount of the first conductive filler particles in the first composite material lies within the range of 0.25 wt-% to 5 wt-%, more preferably 0.5-4 wt-%, and most preferably from 0.5 to 2.0 wt-%, based on the total weight of the first composite material. The relatively low concentration has been found to further improve the space charge behavior without building conductive paths while mechanical properties are maintained good or even improved.

The polymer matrix in the first and/or second composite material may be a polyolefin matrix, such as polyethylene matrix, polypropylene matrix, a co-polymer matrix such as ethylene-propylene or ethylene butadiene, etc., or a blend of different polymers. The polymer matrix may be or may not be a cross-linked polymer matrix. By cross-linking the polyolefin matrix it is rendered more resistant against softening and loss of shape at higher temperatures, such as above 90° C., especially in case the polymer matrix is a low density polyethylene (LDPE). Cross-linkers that can be used may be any known cross-linkers, for example peroxides or azo-compounds.

The first composite material may further comprise at least one additive selected from the group consisting of stabilizers such as antioxidants, nucleating agents, inorganic fillers, cross-linkers, cross-linking boosters such as 2,4,6-triallyl cyanurate, scorch retard agents and flame retardants. Stabilizers, particularly antioxidants prevent negative effects of oxidation. Additives may be used to improve certain properties in the first and/or the second composite material in the cable. The same additives may be used in the second composite material.

The second composite material may comprise the first composite material and second inorganic conductive filler particles, such that the total amount of the first and the second inorganic conductive filler particles is from 17 to 35 wt-%, based on the total weight of the second composite material. The second inorganic conductive filler particles may comprise the first conductive filler particles, carbon black or a combination thereof. By increasing the total amount of the conductive particles in the second composite material such that the content is above percolation threshold, i.e. that a conductive path is formed in the material, a semiconducting material is achieved. Since the first composite material comprises conductive filler particles, the overall content of filler particles may be reduced in the insulation system of the cable.

The cable is preferably a power transmission cable having a rated voltage of 50 kV or higher, and is thus suitable for use as a high voltage transmission power cable. Preferably, the cable is a high voltage direct current (HVDC) cable.

According to a further aspect of the invention, it relates to a process for the production of a transmission power cable as defined above comprising the steps of:

i) providing the first composite material;

ii) providing the second composite material;

iii) providing a metallic conductor;

iv) extruding the second composite material as a first semiconducting layer in the insulation system;

v) extruding the first composite material as a first insulating layer in the insulation system; and optionally

vi) extruding the second composite material as a second semiconducting layer in the insulation system.

Further features and advantages of the present invention will be explained more in detail in the detailed description of the invention below.

### BRIEF DESCRIPTION OF THE DRAWINGS

The invention will be further explained with reference to the appended drawings in which:

FIG. 1 shows schematically a high voltage or medium voltage transmission power cable being laid from a vessel to a ground or to the bottom of the sea;

FIG. 2 is a side view of a high voltage direct current power transmission cable according to the present invention;

FIG. 3 is a cross-section of a high voltage direct current power transmission cable according to the present invention;

FIG. 4 is a cross section of a high voltage alternating current power transmission cable according to the present invention;

FIG. 5 is a flow chart showing the steps of a process for the production of the power transmission cable according to the present invention;

FIG. 6a is a SEM-image of coated mica particles according to the present invention;

FIG. 6b is a SEM-image of coated mica particles according to the present invention with measurements lines shown;

FIGS. 7a and 7b show schematic graphs of space charge measurements of LDPE. FIG. 7a shows a graph of charging and FIG. 7b shows a graph of charge decay;

FIGS. 8a and 8b show schematic graphs of space charge measurements of LDPE including 1 wt-% inorganic conductive filler particles (Minatec). FIG. 8a shows a graph of charging and FIG. 8b shows a graph of charge decay.

### DETAILED DESCRIPTION

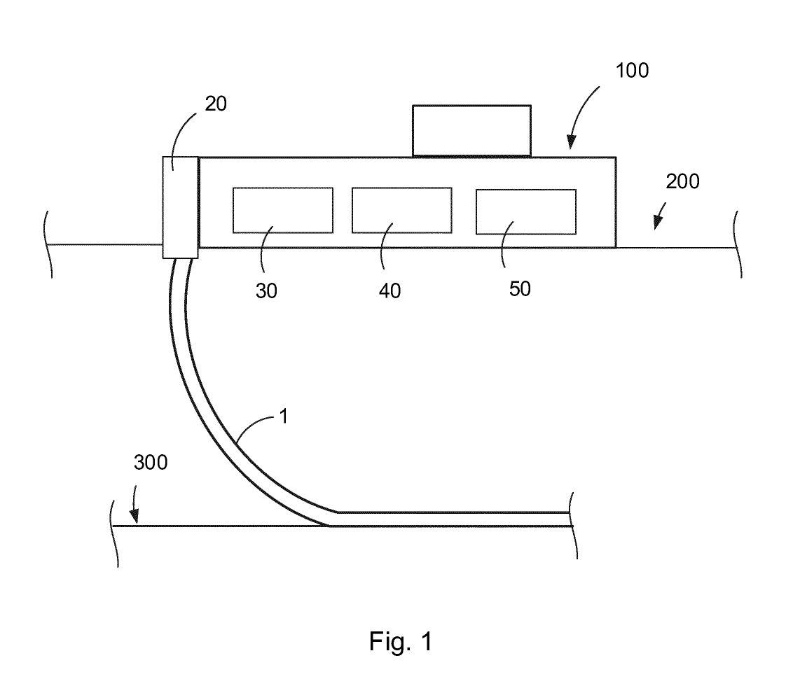

Transmission power cables are used to transfer electrical power from one location to another, and are often buried underground or placed at the bottom of the sea. In this context by transmission power cable is meant a cable that is suitable for use in bulk transfer of electrical energy for example between power plants and electrical substations. FIG. 1 shows schematically a high voltage or medium voltage transmission power cable 1 being laid from a vessel 100 floating on a sea surface 200 to the bottom of the sea 300. The vessel is included with several cable-storage devices 30, 40 and 50 and a feeding device 20. The cable may be buried in the sea bottom or it may be freely located at the sea bed. In case of land cable, the cable can be buried underground.

The transmission power cables according to the present invention may be high voltage direct current (HVDC) cables, high voltage alternating current (HVAC) cables, extra high voltage cables (EHV) and medium-voltage cables.

The transmission power cables comprise a conductor, which is usually mainly constituted by a metal such as copper or aluminum. The conductor is surrounded by an electric insulation system comprising a semiconducting layer, preferably two semiconducting layers, and an insulating layer, wherein the insulating layer is located between the semiconducting layers. Normally, the conductor has a generally circular cross section, even though alternative shapes might be conceived. The surrounding electric insulation system with insulation and semiconducting layers may have a cross-section with an outer peripheral shape corresponding to the outer peripheral shape of the conductor, normally a generally circular outer periphery, and the insulation system may surround the conductor radially and concentrically.

The insulation system can be directly attached to and in immediate contact with the conductor. However, cables in the present invention are not limited to such designs, and there may be further intermediate components provided in between the conductor and the electric insulation system. It should be further understood that the conductor and the insulation system can be surrounded by further material or layers of material. Further materials and layers may have different tasks such as that of holding the different cable parts together, giving the cable mechanical strength and protecting the cable against physical as well as chemical attacks, e.g. corrosion. Such materials and layers are commonly known to the person skilled in the art. For example, such further materials may include armouring, for example steel wires.

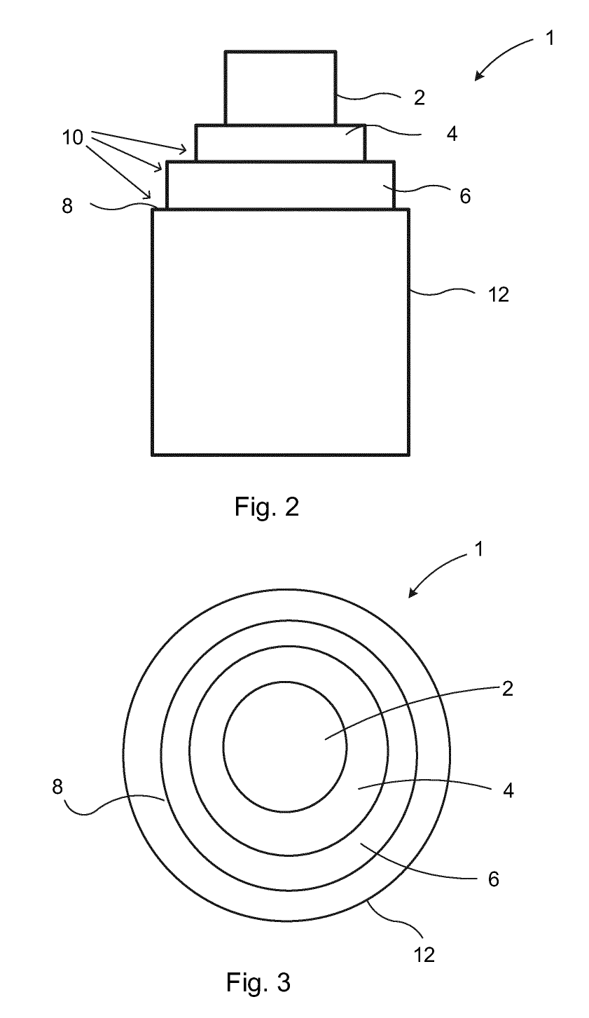

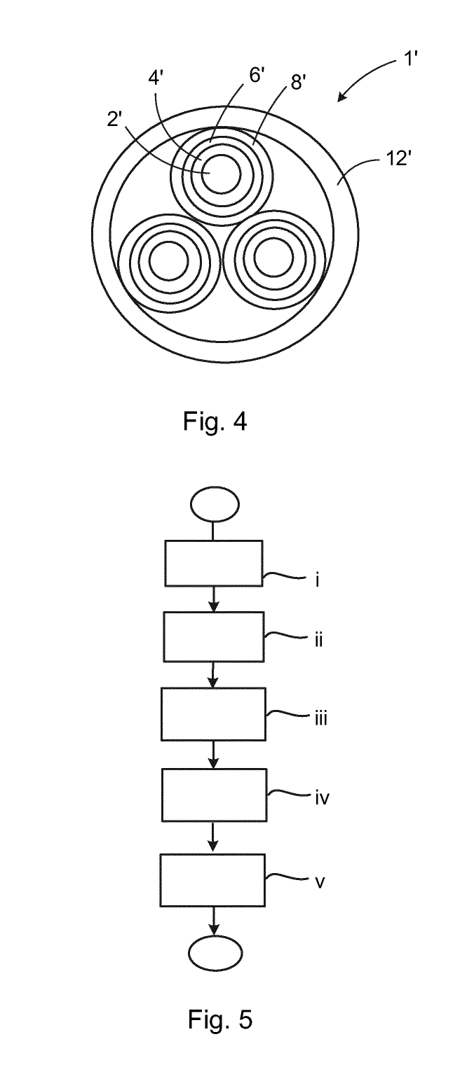

FIG. 2 is a side view of a high voltage direct current (HVDC) power transmission cable 1 according to the present invention, and FIG. 3 shows a cross section thereof. The cable 1 comprises a conductor 2, a first semiconducting layer 4 radially innermost and closest to the conductor 2, a first insulation layer 6 radially surrounding the first semiconducting layer 2 and a second semiconducting layer 8 radially outermost from the conductor. The first semiconducting layer 4, the first insulation layer 6 and the second semiconducting layer 8 together form an insulation system 10 (shown only in FIG. 2) for the transmission power cable 1. There may be more than one insulation layers and there may be more than one semiconducting layers in the insulation system, such as 1-4 insulation layers and 1-4 semiconducting layers. The transmission power cable 1 in FIGS. 2 and 3 is surrounded by an outer sheath 12.

However, it should be understood that the structure of the transmission power cable is not limited to such designs and there may be intermediate components provided between the conductor and the insulation layer(s) and/or semiconducting layer(s). Such further components may have different tasks such as that of holding the different cable parts together, and give the cable mechanical strength and protection against physical as well as chemical attacks, e.g. corrosion, and are commonly known to the person skilled in the art.

As mentioned above, the transmission power cables according to the present invention can also be for example of a type AC transmission power cable. Such cables comprise three conductors, each of which is surrounded by a separate electric insulation system comprising an insulation layer and a semiconducting layer. The HVAC transmission power cable may also comprise further material and layers arranged around and enclosing the rest of the cable as described above. Such further material and layers may have different tasks such as that of holding the different cable parts, as described above, together, and giving the cable mechanical strength and protection, against physical as well as chemical attack, e.g. corrosion, and are commonly known to the person skilled in the art.

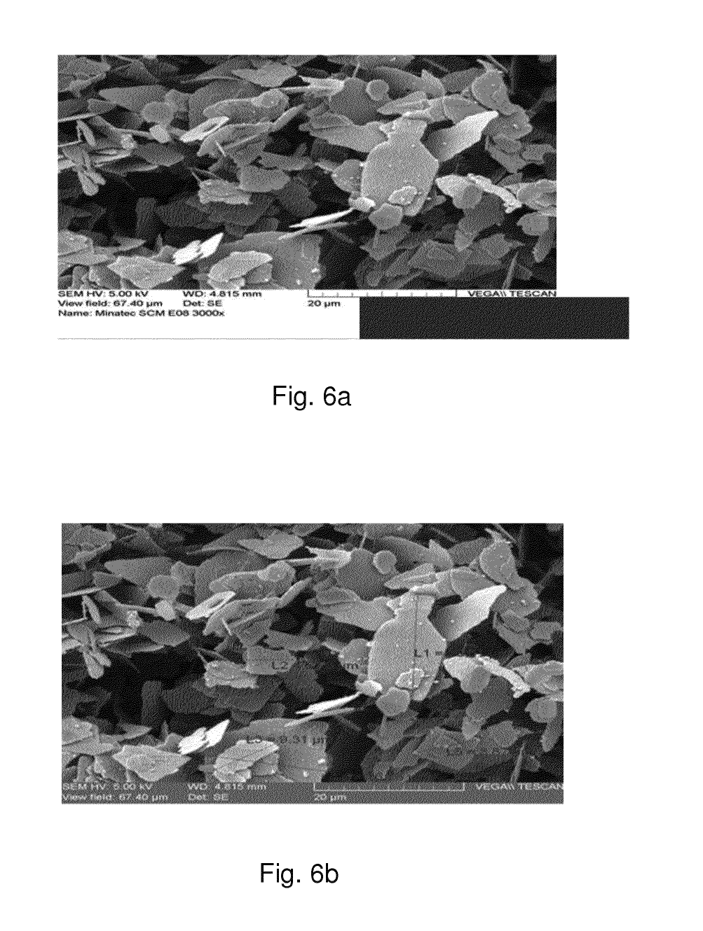

FIG. 4 shows a cross section of a high voltage alternating current power transmission cable 1′ which includes three conductors 2′. For the sake of clarity in the drawing, reference signs are shown only in connection with one conductor including the insulation system, but the other conductors include the same insulation system in this example. Each of the conductors 2′ is radially surrounded by a respective first semiconducting layer 4′ and a first insulation layer 6′ and a second semiconducting layer 8′. The transmission power cable 1′ in FIG. 3 is surrounded by an outer sheath 12′.

Due to the increasing demand of power transmission, more effective and secure power transmission is needed. Thus, there is a need to improve electrical properties of transmission power cables and improve reliability of the transmission cables. As mentioned above, this object is achieved by the present high voltage or medium voltage transmission power cable comprising a metallic conductor and an insulation system comprising an electrical insulation layer comprising a first composite material, and a semiconducting layer comprising a second composite material. According to the invention the first composite material in the insulation layer comprises a polymer matrix and first inorganic conductive filler particles, wherein the amount of the first inorganic conductive filler particles is relatively low and from 0.1 to 10 wt-%, based on the total weight of the first composite material. The first inorganic conductive filler particles are other than carbon black. Carbon black is a material that is carbon black or carbon black-based material, e.g. modified carbon black. Carbon black is a black finely divided form of amorphous carbon produced by incomplete combustion of natural gas or petroleum.

The first composite material in the transmission power cable of the present invention shows improved electrical performance due to the specific filler material compared to the neat polymer. Carbon black is not desirable in the first composite material of the present invention due to the relatively low thermal resistance and relatively low mechanical abrasion and low chemical resistance against e.g. oxidation of carbon black.

By composite material is meant a material comprising two separate material components, for example a polymer matrix and a filler, such as filler particles.

By insulation layer is meant a layer of a material that resists electricity. The conductivity of the insulation material may be for example of from about 1*10⁻⁸ to about 1*10⁻²⁰ S/m at 20° C., typically from 1*10⁻⁹ to 1*10⁻¹⁶. For example, the conductivity of Al₂O₃ is from 10⁻¹⁰ to 10⁻¹² S/m

By semiconducting layer is meant a layer of a material that has an electrical conductivity that is lower than that of a conductor but that is not an insulator. The conductivity of the semiconducting material may be typically of larger than 10⁻⁵ S/m at 20° C., such as up to about 10 or 10² S/m. Typically, the conductivity is less than 10³ S/m at 20° C.

By conductivity is meant the property of transmitting electricity. The conductivity of a conducting material starts from the upper end of a semiconducting material, i.e. from about 10³ at 20° C. For example, carbon black has a conductivity of about 1000 S/m. Basically there is no upper limit, but in practical solutions the upper limit is about 10⁸ S/m at 20° C.

By polymer matrix is meant a polymeric substance that is able to carry and/or enclose another material, for example filler particles.

The First Inorganic Conductive Filler Particles

The first inorganic conductive filler particles may comprise particles of at least one of a metal oxide mineral, alumina, silica, silicates or aluminosilicates. The first inorganic conductive filler particles are coated with a conductive layer to render the particles electrically conductive. The inorganic nature of the particles renders them more resistant to thermo-mechanical or chemical stress compared to organic additives and carbon black. The metal oxide mineral can be for example MgO. The particles are preferably based on alumina or silicate, such as mica. Mica has a crystalline structure that forms layers that can be delaminated into thin sheets. These sheets are chemically inert, dielectric, insulating, lightweight and platy. Mica is stable when exposed to electricity, light, moisture, and extreme temperatures, and is thus suitable for use as a filler particle in the present invention.

The conductive layer of the first conductive filler particles comprises at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SiC, B₄C, WC, W₂C, TiC, ZrC, HfC, NbC, TaC, Cr₃C₂, Mo₂C, SnₓSb_{y}O_{z}, such as SnSbO₂, or a metal layer of aluminium or a noble metal. Preferably, the first inorganic conductive filler particles comprise or consist of inorganic insulation particles such as alumina or silica coated with a conductive layer mentioned above.

According to one embodiment, the inorganic conductive filler particles are carbon-free or essentially carbon-free. By essentially carbon-free is meant a material that does not contain chemically bound carbon, but that may contain a very small amount or residue of carbon. The amount is very small and preferably less than 10000 ppm. The conductive layer or the essentially carbon-free particle may comprises at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SnₓSb_{y}O_{z}, such as SnSbO₂, or a metal layer of aluminum or a noble metal.

Preferably, the inorganic conductive filler particles are based on alumina or silicate, such as mica and preferably coated with SnₓSb_{y}O_{z}, preferably SnSbO₂.

The particles may be also of pure metal, such as of aluminum, e. g. in powder form. Such particles or powders are relatively easy to manufacture and may render the desired electrical properties to the insulation layer.

The concentration of the first conductive filler particles in the first composite material is chosen to be relatively low and is from 0.1 to 10 wt-%, preferably 0.25 wt-% to 5 wt-%, more preferably 0.5-4 wt-%, and most preferably from 0.5 to 2.0 wt-%, based on the total weight of the first composite material so that a percolation threshold is not reached and no conductive path is built up. If percolation threshold is reached, a conductive path is formed in the material and it will not be electrically insulating. Therefore, the increase of conductivity of the composite material by addition of the first conductive filler, alternating current (AC) or direct current (DC), should preferably be less than two decades referring to the conductivity value of the neat polymer.

The use of such conductive fillers in the insulation layer, i.e. when no percolation occurs, is beneficial for reduction of space charge accumulation as they trap charges and also for acceleration of space charge decay once it has occurred. This feature provides a large improvement to the insulation and is especially advantageous in DC cables. A further advantage is that the first composite material is tolerant towards conductive impurities compared to a super-clean insulation, since conductive fillers are introduced and well dispersed in the matrix.

The size of the conductive filler particle can vary from 0.1 to 100 μm. By size is meant the largest dimension of the particle, measured as the largest dimension of the particle visible in a SEM (Scanning electron microscope) image. Preferably, the conductive inorganic filler has a platelet-like shape. By platelet-like is meant that the length and width dimensions of the particle are larger than the thickness dimension of the particle. Platelet-like filler particles can further improve the dielectric strength of insulation materials.

Polymer Matrix

The polymer matrix in the first composite material comprises an extrudable, i.e. thermoplastic, polymer. Any polymer matrix that can be processed via melt extrusion is applicable and can be used as the polymer matrix in the present invention. The polymer matrix is preferably a polyolefin, such as polyethylene, polypropylene or thermoplastic elastomers or mixtures thereof, polyurethane or cross-linked polyethylene (XLPE) or ethylene-propylene-diene M-class rubber (EPDM). Especially in medium voltage transmission cables XLPE is widely used and in high voltage (AC and DC) LDPE is used as a base resin.

The main purpose for additional cross-linking of LDPE is the improvement of dimensional and therefore thermo-mechanical stability while keeping its high flexibility. LDPE has a rather low melting point of around 115° C. and with XLPE no melting and therefore no large softening and loss of shape will occur above 110° C. For example, AC-cables operate with a rated maximum conductor temperature of 90° C. and a 250° C. short circuit rating. Cross-linkers that can be used may be any known cross-linkers, for example peroxides or azo-compounds. The two major chemical cross-linking routes, as applied industrially, involves either dicumyl peroxide (DCP) for HV and MV or silane cross-linking agents for MV cables.

Preferably, the polymer matrix comprises cross-linked polyethylene or ethylene-propylene-based polymer. As mentioned above, these materials render the insulation layer relatively thermally stable while an effective insulation property is obtained.

Additives

The first composite material may further comprise at least one additive selected from the group consisting of stabilizers such as antioxidants, nucleating agents, inorganic fillers, cross-linkers, cross-linking boosters such as 2,4,6-triallyl cyanurate, scorch retard agents and flame retardants. Stabilizers, particularly antioxidants prevent negative effects of oxidation. Additives may be used to improve certain properties in the first and/or the second composite material in the cable. The same additives may be used in the second composite material. The additive may be added in an amount of about 0-25 wt-%, based on the total weight of the first or second composite material. Usually, the concentration of additives is kept under about 3 wt-%, based on the total weight of the first or second composite material, but for example flame retardants in medium voltage cables can be used in higher concentrations.

Examples of inorganic additives are silica and aluminum trihydrate (Al₂O₃.3H₂O), glass powder, chopped glass fibers, metal oxides such as silicon oxide (e.g. Aerosil, quartz, fine quartz powder) metal hydroxides, metal nitrides, metal carbides, natural and synthetic silicates or mixtures thereof. Aluminum trihydrate or silicon oxide (e.g. Aerosil, quartz, fine quartz powder) are particularly preferred as inorganic additives. Also, the average particle size distribution of such fillers and their quantity present within the polymer composition corresponds to that average particle size distribution and quantity usually applied in electrical high voltage insulators.

Examples of suitable metals for metal oxides, metal hydroxide, metal nitrides or metal carbides are aluminum, bismuth, cobalt, iron, magnesium, titanium, zinc, or mixtures thereof.

One or more inorganic oxides or salts such as CoO, TiO₂, Sb₂O₃, ZnO, Fe₂O3, CaCO₃ or mixtures thereof, may advantageously be added to the inventive first or second composite material in minor amounts.

Preferably, the above-mentioned metal hydroxides—in particular magnesium and aluminum hydroxides—are used in the form of particles having sizes which can range from 0.1 to 100 μm, preferably from 0.5 to 10 μm. In the case of hydroxides, these can advantageously be used in the form of coated particles. Saturated or unsaturated fatty acids containing from 8 to 24 carbon atoms, and metal salts thereof are usually used as coating materials, such as, for example: oleic acid, palmitic acid, stearic acid, isostearic acid, lauric acid, magnesium or zinc stearate or oleate, and the like.

Second Composite Material

The second composite material, which is used in the semiconducting layer of the transmission power cable of the present invention, preferably comprises the first composite material and second inorganic conductive filler particles, such that the total amount of the first and the second inorganic conductive filler particles is from 17 to 35 wt-%. Since the first composite material comprises conductive filler particles, the overall content of filler particles may be reduced in the insulation system of the cable according to the present invention. In the manufacture of the cable the first composite material of the insulation layer is often used as a base material for the second composite material of the semi-conducting layer. According to the present invention, the first composite material already contains conductive filler particles of from 0.1-10 wt-%. Thus, to render the second composite material conductive a smaller addition of further conductive filler particles is needed, e.g. as little as 7 wt-%, than in the prior art solutions in which the first composite material contains insulating filler particles.

The second composite material may comprise a cross-linkable LDPE formulation and may contain further additives such as primary and secondary antioxidants, scorch retard agents, dispersants or other inorganic fillers.

The semi-conductive layer as applied in HV and MV cables may comprise the same or other polymer matrix and also the conductive inorganic filler as in the first composite material. Electrical properties, e.g. conductivity, are then adjusted by addition of conductive fillers such as carbon black with content above percolation threshold. In such a way the concentration of the conductive particles can be adjusted to be sufficient to render the material semi-conductive. The second inorganic conductive filler particles may comprise the first conductive filler particles, i.e. the second inorganic conductive filler particles may be of the same kind as the first conductive filler particles, or the second inorganic conductive filler particles may be carbon black or a combination thereof. The second filler particles may also be of metal, such as aluminum in powder form.

Manufacturing

The transmission power cable may be manufactured by using any known technology. The first composite material and/or the second composite material may be manufactured as a pre-compounded composite. For manufacturing a pre-compounded composite of polymers and filler and also other additives, any blending technique such as melt blending (kneading or extrusion) or solution blending can be applied. In the special case of cross-linkable PE, the cross-linker such as DCP may be diffused into the pre-compounded PE-filler composite. Diffusion may take place via the gas phase upon heat and pressure or via liquid phase applying an appropriate solvent. Other cross-linking methods may be of course used.

The pre-compounded blend can then be used in a standard cable extrusion process, e.g. in a continuous vulcanization (CV) line, in order to obtain the final cable with the targeted insulation material.

In an alternative method, the filler and possibly additives may be fed directly into LDPE or XLPE during the cable extrusion process.

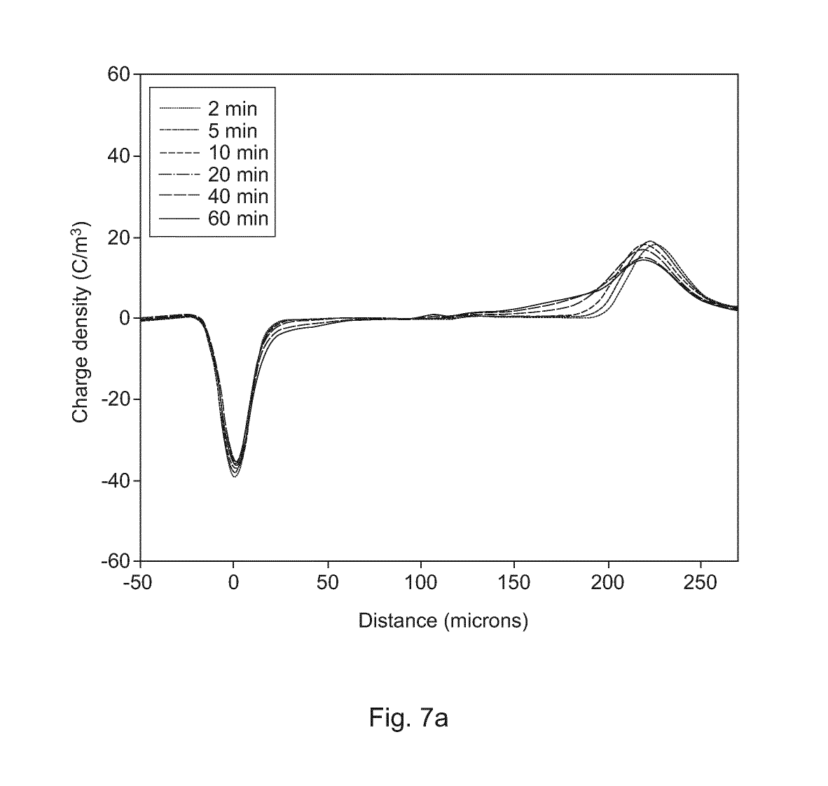

The process for the production comprises generally the following steps and is illustrated in FIG. 5:

i) providing the first composite material;

ii) providing the second composite material;

iii) providing a metallic conductor;

iv) extruding the second composite material as a first semiconducting layer in the insulation system;

v) extruding the first composite material as a first insulating layer in the insulation system; and optionally

vi) extruding the second composite material as a second semiconducting layer in the insulation system.

### Examples

Materials

The following materials were used in the examples:
Low density polyethylene (LDPE): Lupolen 3020H—pure grade without additives
Conductive filler: Minatec SCM E08—mica platelets (<100 μm) with conductive coating based on SnₓSb_{y}O_{z}

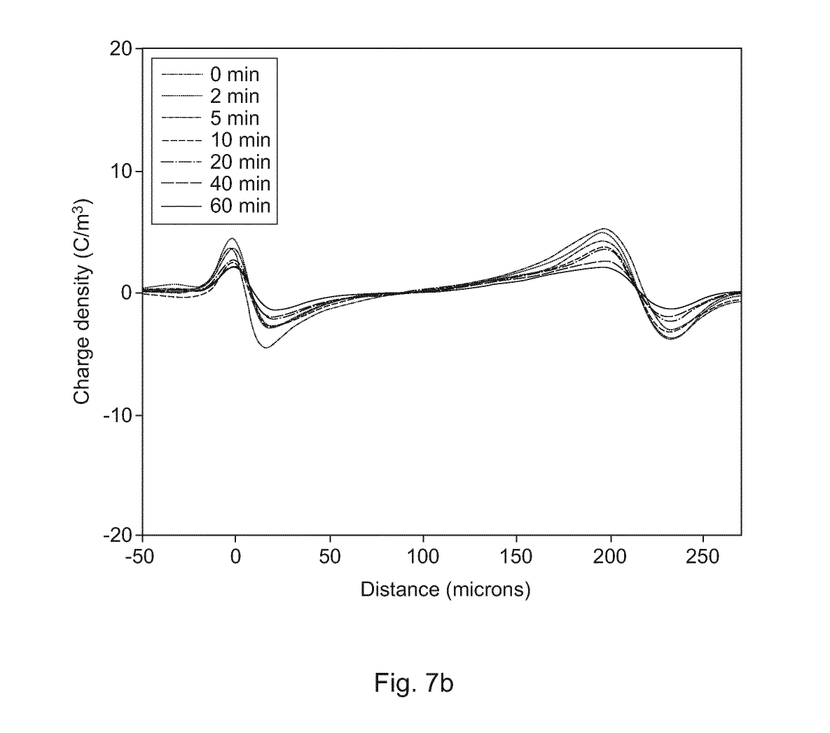

FIGS. 6a and 6b show SEM-images of the conductive filler particles used in the composite insulation material. From the SEM-images it can be measured that the particles can have a longest dimension in the two-dimensional plane of 25.61 μm, which is less than 100 μm. It should be noted that the particles lie in three-dimensional plane, while the SEM-image is two dimensional, and some variation between the measured and the actual particle size may occur.

Methods

To prepare the first composite material of the invention, melt blending of LDPE with Minatec filler was performed using a twin screw extruder HAAKE Rheomex OS PTW24 at 180-190° C. Different amounts, i.e. 0 wt-%, 0.5 wt-%, 1 wt-% and 2 wt %, of the filler were used.

In order to manufacture a cross-linkable grade of the produced granules of the first composite material, the produced granules were treated with 1.3 phr (parts per hundred parts of resin) DCP (dicumyl peroxide) in the following procedure:
1. Dry the pure pellets in vacuum oven for 24 h at 70° C.
2. Add DCP to the pellets together in an autoclave.
3. Shake manually for 10 min and place in closed autoclave for 20 h at 75° C.
4. Dry the pellets in a vacuum overnight.

Plaque samples from cross-linkable LDPE composites were pressed at 180° C. or 200° C. and 200 bar in a hot press. In case of XLPE (cross-linked polyethylene) plates, no degassing was applied.

AC dielectric strength (60 Hz) was measured using a Bauer DTA 100 equipment on 45×45×1 mm³ specimens with Nytro 10XN oil with a voltage raise of 2 kV/s. Specimens were placed among brass spherical electrodes with 12.5 mm diameter in the sample cell.

Room temperature space charge measurements were performed on 0.15 mm thickness samples using a PEANUTS pulsed electro-acoustic system (5-Lab) applying both a constant DC voltage to the sample as well as a 400 Hz/600 V signal for the measurement of space charge and employing a PVDF sensor.

DC conductivity was determined at 70° C. and 20 kV/mm on 1 mm thick plates with value taken after 24 and 100 hours.

The gel content—reflecting the degree of cross-linking density—was determined by Soxhlet extraction in para-xylene for 14 hours and determination of the using a sample of 1 g (cut from the plate).

Mechanical properties were measured in tensile tests according to ISO 527-2.

Results

Electrical Properties

Dielectric Strength and DC Conductivity

TABLE 1
Measured Dielectric strength and DC conductivity of
LDPE and a composite comprising LDPE and Minatec.

| | | LDPE + | LDPE + | LDPE + |
|---|---|---|---|---|
| | | 0.5 wt % | 1 wt % | 2 wt % |
| | LDPE | Minatec | Minatec | Minatec |
| AC dielectric strength | 60 ± 8 | 59 ± 4 | 63 ± 4 | 61 ± 4 |
| with Bauer DTA 100 | | | | |
| [kV/mm] | | | | |
| DC conductivity [S/m] | 2 × 10⁻¹⁵ | 2 × 10⁻¹⁵ | 3 × 10⁻¹⁵ | 6 × 10⁻¹⁵ |

TABLE 2
Measured Dielectric strength and DC conductivity of
XLPE and a composite comprising XLPE and Minatec.

| | | XLPE + | XLPE + |
|---|---|---|---|
| | | 1 wt % | 2 wt % |
| | XLPE | Minatec | Minatec |
| AC dielectric strength | 57 ± 9 | 56 ± 4 | 53 ± 2 |
| with Bauer DTA 100 | | | |
| [kV/mm] | | | |
| DC conductivity [S/m] | 59 × 10⁻¹⁵ | 30 × 10⁻¹⁵ | 20 × 10⁻¹⁵ |

Observations and Conclusions

It can be seen from the results that similar dielectric strength for both LDPE and XLPE were obtained with the inclusion of conductive Minatec fillers of up to 2 wt-%. However, there is a noticeable improvement of scattering when using fillers, e.g. in the dielectric strength results, whereby it can be seen that the Minatec fillers have a stabilizing effect in the composite material.

From the results it can also be seen that significant reduction of DC conductivity is achieved with introduction of Minatec (1 wt-%) in case of XLPE.

Space Charge

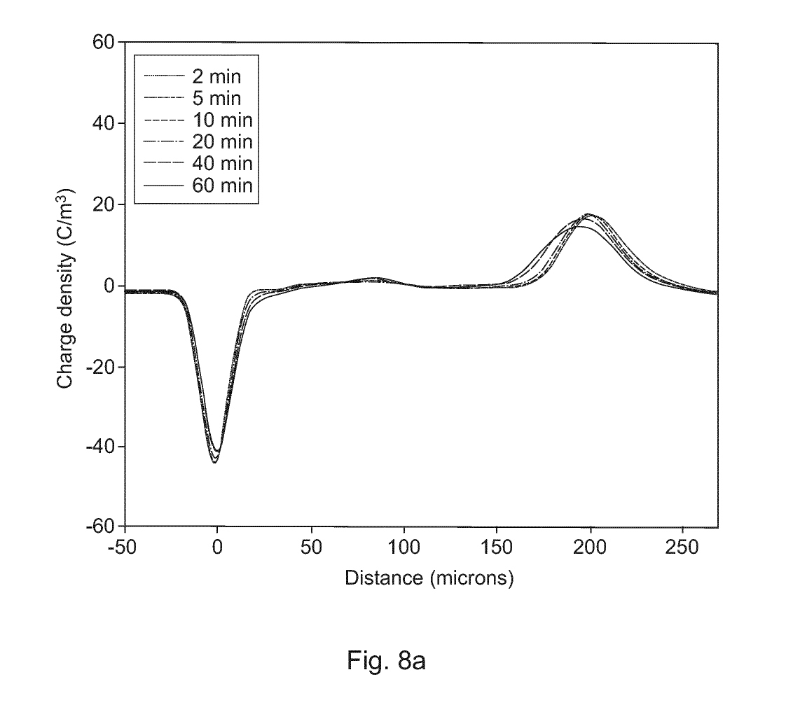

FIGS. 7a and 7b shows a diagram from space charge measurements of LDPE. FIG. 7a shows a diagram of charging and FIG. 7b shows a diagram of charge decay.

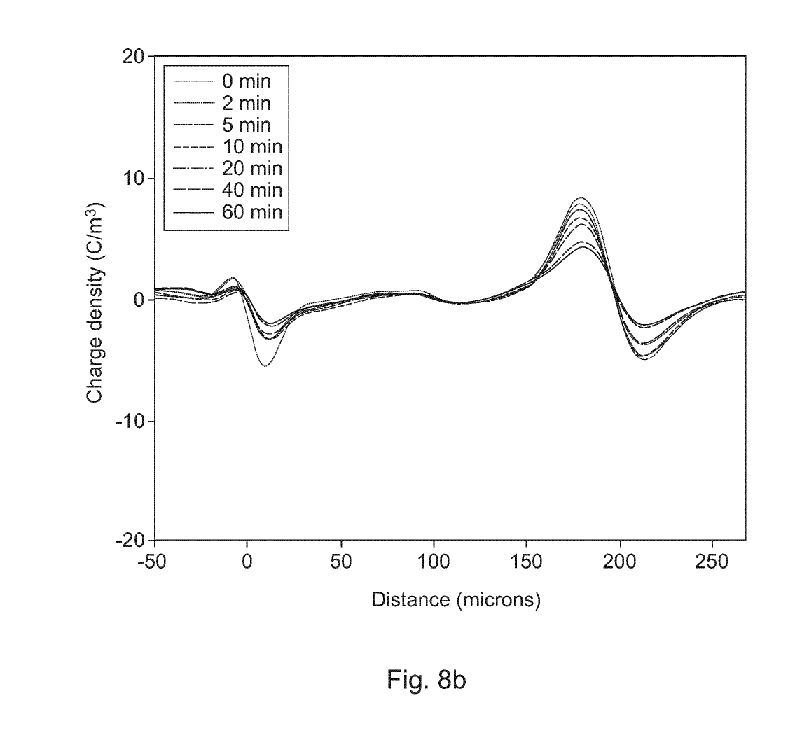

FIGS. 8a and 8b show a diagram from space charge measurements of LDPE including 1 wt-% Minatec. FIG. 8a shows a diagram of charging and FIG. 8b shows a diagram of charge decay.

In the FIGS. 7a, 7b, 8a and 8b, an electrode is positioned at about 0 microns distance and at about 200 microns distance, whereby the charge density decreases or increases accordingly. It can be seen e.g. in FIG. 7a that the charge density in insulation close to the first electrode at distance 0 is negative and thus there is a homocharge. Similarily, the charge density in insulation close to the second electrode at 200 is positive, and thus there is a homocharge.

Observations and Conclusions

From the measurements it can be concluded that there is significant homocharge accumulation—especially at the anode close to the position of the electrode in FIG. 7a, showing space charge measurements of LDPE, and on charging in case of pure LDPE. Further, as can be concluded from FIG. 7b showing charge decay, there is large charge storage which persists after 1 hour and penetrates a significant distance into the bulk.

It can be also seen from FIG. 8a that there is a decreased homocharge accumulation on charging in case of LDPE+1 wt-% Minatec. Also, there is much less penetration into the sample compared to pure LDPE as can be seen from FIG. 8b. Thus, there is a clear suppression of charge penetration into the bulk by addition of conductive Minatec.

Mechanical Properties

Mechanical properties of the composite material were also investigated.

Young Modulus is a measure of the stiffness of the material and is equal to the ratio of the applied load per unit area of cross section to the increase in length per unit length.

Yield stress is a stress level at which a metal or other material ceases to behave elastically. The stress divided by the strain is no longer constant and the point at which this occurs is known as the yield point. Yield strain is a measure of deformation caused by the stress. Stress at break is the measure of the stress at a break point and strain at break is the measure of deformation at break.

TABLE 3
Measured mechanical properties of LDPE and
a composite comprising LDPE and Minatec

| | | LDPE + | LDPE + | LDPE + |
|---|---|---|---|---|
| | | 0.5 wt % | 1 wt % | 2 wt % |
| | LDPE | Minatec | Minatec | Minatec |
| Young Modulus [MPa] | 157 ± 26 | 221 ± 18 | 263 ± 14 | 268 ± 47 |
| Yield stress [MPa] | 13.0 ± 0.6 | 14.3 ± 0.5 | 14.7 ± 0.2 | 14.5 ± 0.6 |
| Yield strain [%] | 12.3 ± 0.5 | 11.3 ± 0.4 | 9.9 ± 0.7 | 10.5 ± 0.3 |
| Stress at break [MPa] | 10.5 ± 0.7 | 11.4 ± 0.6 | 11.7 ± 1.1 | 11.5 ± 0.6 |
| Strain at break [%] | 248 ± 57 | 227 ± 45 | 132 ± 44 | 64 ± 11 |

TABLE 4
Measured mechanical properties of XLPE and
a composite comprising XLPE and Minatec

| | | XLPE + | XLPE + |
|---|---|---|---|
| | | 1 wt % | 2 wt % |
| | XLPE | Minatec | Minatec |
| Young Modulus [MPa] | 176 ± 28 | 169 ± 18 | 207 ± 39 |
| Yield stress [MPa] | 9.8 ± 0.9 | 10.5 ± 0.4 | 10.9 ± 0.9 |
| Yield strain [%] | 15.5 ± 1.0 | 13.6 ± 1.7 | 13.4. ± 0.7 |
| Stress at break [MPa] | 11.8 ± 1.8 | 12.1 ± 0.5 | 12.9 ± 1.3 |
| Strain at break [%] | 275 ± 32 | 209 ± 12 | 61 ± 7 |

Observations and Conclusions

It can be concluded that mechanical reinforcement of the composite material occurs by addition of Minatec fillers for both LDPE and XLPE in respect mechanical strength (stress at yield and break). The stiffness (Young modulus) increases slightly.

Thus, it can be concluded that both electrical and mechanical properties are improved with the filler material of the present invention compared to the neat polymer.

One skilled in the art will appreciate that the technology presented herein is not limited to the embodiments disclosed in the accompanying drawings and the foregoing detailed description, which are presented for purposes of illustration only, but it can be implemented in a number of different ways, and it is defined by the following claims.

1-16. (canceled)

17. A high voltage or medium voltage transmission power cable comprising a metallic conductor and an insulation system comprising an electrical insulation layer comprising a first composite material, and a semiconducting layer comprising a second composite material, and wherein the insulation layer and the semiconducting layer are arranged to surround the conductor, wherein the first composite material in the insulation layer comprises a polymer matrix which is a polyolefin matrix and first inorganic conductive filler particles, wherein the amount of the first inorganic conductive filler particles is from 0.1 to 10 wt-%, based on the total weight of the first composite material, and wherein the first inorganic conductive filler particles are other than carbon black, and the first inorganic conductive filler particles comprise particles of at least one of a metal oxide mineral, alumina, silica, silicates or aluminosilicates, and wherein the first inorganic conductive filler particles are coated with a conductive layer, and wherein the second composite material comprises the first composite material and second inorganic conductive filler particles, such that the total amount of the first and the second inorganic conductive filler particles is from 17 to 35 wt-%.

18. The high voltage or medium voltage transmission power cable according to claim 17, wherein the first inorganic conductive filler particles are based on alumina or silicate.

19. The high voltage or medium voltage transmission power cable according to claim 17, wherein the first inorganic conductive filler particles are based on mica particles.

20. The high voltage or medium voltage transmission power cable according to claim 17, wherein the first inorganic conductive filler particles are essentially carbon-free.

21. The high voltage or medium voltage transmission power cable according to claim 20, wherein the conductive layer of the first conductive filler particles comprises at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SnₓSb_{y}O_{z} or a metal layer of aluminum or a noble metal.

22. The high voltage or medium voltage transmission power cable according to claim 17, wherein the conductive layer of the first conductive filler particles comprises at least one of TiO₂, V₂O₅, Cr₂O₃, MnO, Fe₂O₃, CoO, NiO, Cu₂O, ZnO, ZnS, Ta₂O₅, Y₂O₃, ZrO₂, Nb₂O₅, MoO₃, In₂O₃, SnO₂, La₂O₃, Ta₂O₅, WO₃, SiC, B₄C, WC, W₂C, TiC, ZrC, HfC, NbC, TaC, Cr₃C₂, Mo₂C, SnₓSb_{y}O_{z} or a metal layer of aluminium or a noble metal.

23. The high voltage or medium voltage transmission power cable according to claim 21, wherein the conductive layer is based on SnₓSb_{y}O_{z}.

24. The high voltage or medium voltage transmission power cable according to claim 17, wherein the first inorganic conductive particles have a platelet-like shape.

25. The high voltage or medium voltage transmission power cable according to claim 17 wherein the largest dimension of the first conductive filler particles is from 0.1 to 100 μm, measured as the largest dimension of the particle visible in a SEM-image.

26. The high voltage or medium voltage transmission power cable according to claim 17, wherein the amount of the first conductive filler particles in the first composite material is within the range of 0.25 wt-% to 5 wt-% based on the total weight of the first composite material.

27. The high voltage or medium voltage transmission power cable according to claim 17, wherein the polymer matrix is a cross-linked polymer.

28. The high voltage or medium voltage transmission power cable according to claim 17, wherein the first composite material comprises at least one additive selected from the group consisting of stabilizers such as antioxidants, nucleating agents, inorganic fillers, cross-linkers, cross-linking boosters, scorch retard agents and flame retardants.

29. The high voltage or medium voltage transmission power cable according to claim 17, wherein the cable is a power transmission cable having a rated voltage of 50 kV or higher.

30. The high voltage or medium voltage transmission power cable according to claim 17, wherein the cable is a high voltage direct current (HVDC) cable.

31. The high voltage or medium voltage transmission power cable according to claim 17, wherein the second inorganic conductive filler particles comprise the first conductive filler particles and carbon black.

32. A process for the production of the transmission power cable according to claim 17 comprising the steps of:
providing the first composite material;
providing the second composite material;
providing a metallic conductor;
extruding the second composite material as a first semiconducting layer in the insulation system;
extruding the first composite material as a first insulating layer in the insulation system; and optionally
extruding the second composite material as a second semiconducting layer in the insulation system.

33. The high voltage or medium voltage transmission power cable according to claim 17, wherein the amount of the first conductive filler particles in the first composite material is within the range of 0.5-4 wt-% based on the total weight of the first composite material.

34. The high voltage or medium voltage transmission power cable according to claim 17, wherein the amount of the first conductive filler particles in the first composite material is within the range of 0.5 to 2.0 wt-% based on the total weight of the first composite material.

35. The high voltage or medium voltage transmission power cable according to claim 18, wherein the first inorganic conductive filler particles are based on mica particles.

36. The high voltage or medium voltage transmission power cable according to claim 18, wherein the first inorganic conductive filler particles are essentially carbon-free.
